(19) United States
(12) Patent Application Publication
(10) Pub. No.: US 2026/0339084 A1
(43) Pub. Date: Oct. 29, 2026

(54) SCANNING OBSERVATION APPARATUS

(71) Applicant: CANON KABUSHIKI KAISHA, Tokyo (JP)

(72) Inventors: MAKOTO KAWAGUCHI, Kanagawa (JP); MITSUHIRO IKUTA, Kanagawa (JP)

(21) Appl. No.: 19/698,197

(22) Filed: Jun. 4, 2026

Related U.S. Application Data
(63) Continuation of application No. PCT/JP2024/041321, filed on Nov. 21, 2024.

(30) Foreign Application Priority Data
Dec. 4, 2023 (JP) 2023-204961

(51) Int. Cl. G02B 21/00; G01N 21/65; G02B 21/04

(52) U.S. Cl. CPC G02B 21/002; G01N 21/65; G02B 21/04; G01N 2021/655

(57) ABSTRACT

A scanning observation apparatus includes a first emission optical system that emits spatially modulated first primary light and a second emission optical system that emits coherent second primary light. A combining unit coaxially combines the two beams, and a scanning unit scans the combined light coaxially. A first objective lens focuses the scanned beams onto a sample placed at the focal point. Secondary light from the sample is collected by a second objective lens and split into first secondary light generated by the first primary light and second secondary light generated by the second primary light. A first detection unit detects the first secondary light, and a second detection unit detects the second secondary light.

### CROSS-REFERENCE TO RELATED APPLICATIONS

This application is a Continuation of International Patent Application No. PCT/JP2024/041321, filed Nov. 21, 2024, which claims the benefit of Japanese Patent Application No. 2023-204961, filed Dec. 4, 2023, both of which are hereby incorporated by reference herein in their entirety.

### BACKGROUND

### Field of the Technology

The present disclosure relates to a scanning observation apparatus.

### Description of the Related Art

In recent years, a method for observing or evaluating a live cell without staining it has been increasingly demanded in the fields of regenerative medicine, rapid intraoperative diagnosis, bioproduction, and the like. Examples of methods for imaging a live cell without staining and in a non-contact manner include a method of detecting a phase difference of light transmitted through the cell and a method of detecting Raman-scattered light generated by molecular vibrations of molecules constituting the cell.

Japanese Patent Laid-Open No. 2019-35859 describes an apparatus that allows a live cell to be observed using both a phase contrast imaging method for detecting a phase difference as light intensity, and a coherent anti-Stokes Raman scattering (CARS) imaging method of detecting anti-Stokes Raman scattering light generated due to a nonlinear optical effect.

According to Japanese Patent Laid-Open No. 2019-35859, while a phase contrast image is acquired by illuminating an entire observation region once and imaging the region using a charge-coupled device (CCD) camera, a CARS image is acquired by condensing illumination light to one point in the observation region and scanning the condensed illumination light. In other words, different image forming means are used in different imaging methods. This leads to inconsistency between the image qualities of primary images acquired from the respective imaging methods, resulting in, for example, a difference between observation regions and a mismatch between the numbers of pixels. Consequently, pre-calibration of the apparatus and post-processing of the images, both of which have been cumbersome for an operator, have been required to make the image qualities consistent. In this respect, reducing the burden on operators who want to observe live cells using a plurality of techniques has been desired.

### SUMMARY

The present disclosure is directed to providing a scanning observation apparatus that readily enables a phase difference image and a Raman image to be obtained with consistent image qualities.

According to an aspect of the present disclosure, a scanning observation apparatus includes a first emission optical system configured to emit first primary light containing a spatially modulated component, a second emission optical system configured to emit coherent second primary light, a combining unit configured to coaxially combine the first primary light and the second primary light, a scanning unit configured to coaxially scan the combined first primary light and second primary light, a first objective lens configured to condense the scanned first primary light and second primary light, a placement unit configured to place a sample at a light condensation point of the first objective lens, a second objective lens configured to collect secondary light from the sample, a splitting unit configured to split the secondary light into first secondary light exiting from the sample by irradiation with the first primary light, and second secondary light exiting from the sample by irradiation with the second primary light, a first detection unit configured to detect the first secondary light, and a second detection unit configured to detect the second secondary light.

Features of the present disclosure will become apparent from the following description of embodiments with reference to the attached drawings.

### BRIEF DESCRIPTION OF THE DRAWINGS

FIG. 1 is a block diagram illustrating an overview of connection relationships between elements included in an observation apparatus according to a first embodiment of the present disclosure.

FIG. 2 is a schematic view illustrating the configuration of the observation apparatus according to the first embodiment.

FIG. 3 is a schematic view illustrating phase difference observation by the observation apparatus according to the first embodiment.

FIG. 4 is a schematic view illustrating stimulated Raman scattering (SRS) observation by the observation apparatus according to the first embodiment.

FIG. 5A is a flowchart illustrating a procedure that is executed before observation by the observation apparatus according to the first embodiment.

FIG. 5B is a diagram illustrating the relationship between a region of interest and an observation field of view according to the first embodiment.

FIG. 5C is a diagram illustrating an overview of a configuration of a scanning condition determination unit according to the first embodiment.

FIG. 6 is a schematic view illustrating a configuration of an observation apparatus according to a second embodiment.

FIG. 7A is a schematic view illustrating a relationship between a phase plate and transmitted light fluxes at a phase difference detection unit according to the second embodiment.

FIG. 7B is a schematic view illustrating a relationship between the phase plate and the transmitted light fluxes at the phase difference detection unit according to the second embodiment.

### DESCRIPTION OF THE EMBODIMENTS

Hereinafter, embodiments of the present disclosure will be described with reference to the accompanying drawings.

### First Embodiment

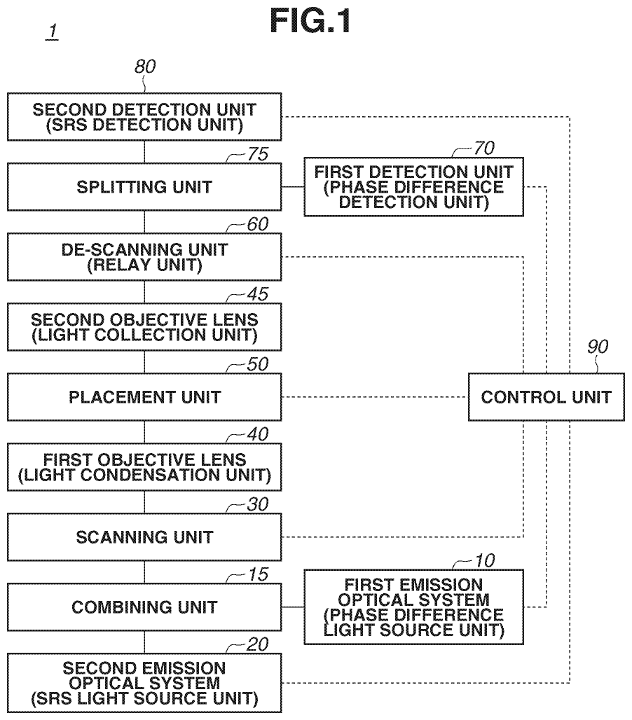

A configuration of an observation apparatus 1 according to a first embodiment will be described with reference to FIGS. 1 to 5C.

FIG. 1 is a block diagram illustrating an overview of connection relationships between elements included in the observation apparatus 1. In FIG. 1, a solid line that connects blocks (rectangles) represents an optical connection between corresponding components, and a broken line that connects blocks (rectangles) represents establishment of a connection allowing a signal regarding measurement or control to be transmitted between corresponding components.

The observation apparatus 1 includes a first emission optical system 10 (a phase difference light source unit), a second emission optical system 20 (a stimulated Raman Scattering (SRS) light source unit), a combining unit 15, a scanning unit 30, a first objective lens 40, and a placement unit 50, which are optically connected. The observation apparatus 1 further includes a second objective lens 45, a de-scanning unit 60 (relay unit), a splitting unit 75, a first detection unit 70 (a phase difference detection unit), and a second detection unit 80 (an SRS detection unit). In addition, the observation apparatus 1 includes a control unit 90. The control unit 90 is electrically connected to the first emission optical system 10 (the phase difference light source unit), the second emission optical system 20 (the SRS light source unit), the scanning unit 30, the placement unit 50, the relay unit 60, the first detection unit 70 (the phase difference detection unit), and the second detection unit 80 (the SRS detection unit).

In the observation apparatus 1, the first emission optical system 10 (the phase difference light source unit) and the second emission optical system 20 (the SRS light source unit) serve as a first emission optical system and a second emission optical system, respectively. Further, the first detection unit 70 (the phase difference detection unit) and the SRS detection unit serve as a first detection unit and a second detection unit, respectively.

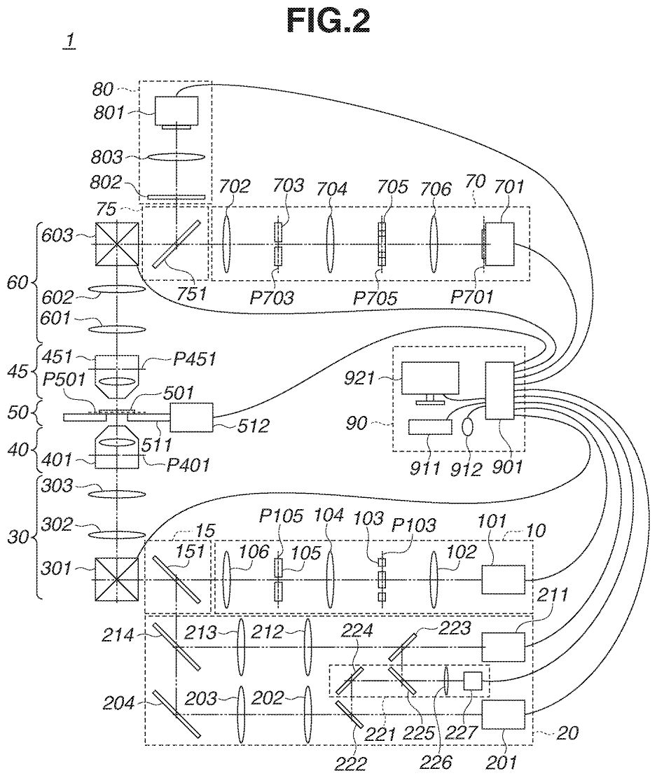

FIG. 2 is a schematic view illustrating a configuration of the observation apparatus 1.

### (Placement Unit)

The placement unit 50 includes a stage 511 and a stage scanner 512. The stage 511 supports a sample 501, which is an observation target of the observation apparatus 1, in such a manner that a light condensation position of the first objective lens 40, which will be described below, and the sample 501 at least partially overlap each other. The placement unit 50 may be alternatively referred to as a support unit 50 for the sample 501 or a sample stage 50. The light condensation position of the first objective lens 40 may be alternatively referred to as a focal point of the first objective lens 40, a light condensation point of the first objective lens 40, or the like.

The stage 511 includes an optically apertured portion that allows primary light to enter the sample 501 and secondary light to exit the sample 501. The aperture may be circumferentially closed (annular) or circumferentially open (non-annular).

This configuration allows the sample 501 placed on the placement unit 50 to be irradiated with light from the first objective lens 40 through the stage 511. The stage scanner 512 is joined with the stage 511. The stage scanner 512 moves the stage 511 in parallel with the surface on which the sample 501 is placed. Thus, an operator can easily move a portion of the sample 501 that the operator wants to observe to an observation region of the observation apparatus 1 after placing the sample 501. Further, the stage scanner 512 moves the stage 511 perpendicularly to the surface on which the sample 501 is placed. Thus, the operator can easily bring the sample 501 into focus and three-dimensionally observe the sample 501.

### (First Objective Lens and Second Objective Lens)

The first objective lens 40 and the second objective lens 45 include objective lenses 401 and 451, respectively. The objective lenses 401 and 451 are disposed at positions opposite from each other with respect to the stage 511. The objective lenses 401 and 451 are disposed to share a focal plane P501. This focal plane P501 may be alternatively referred to as a sample plane P501. In this case, a conjugate positional relationship is established between pupil planes P401 and P451 included in the objective lenses 401 and 451, respectively. This can help to suppress acquisition of an obscure phase difference image, superimposition of an artifact on an acquired SRS image and SRS spectrum, and a reduction in detection sensitivity. It is desirable that the objective lenses 401 and 451 be arranged in such a manner that both on-axis and off-axis focal points thereof match each other over wavelengths from the visible range to the near-infrared range. Therefore, it is desirable that longitudinal chromatic aberration and lateral chromatic aberration be sufficiently corrected. This can help to suppress misalignment in a horizontal direction (i.e., a direction of the sample plane P501) and a depth direction (i.e., an optical axis direction) between the SRS image and the phase difference image, which improves the observation accuracy. Further, it is desirable that the objective lenses 401 and 451 have the same numerical aperture. This can help to suppress artifacts superimposed on the acquired SRS image and SRS spectrum.

### (Phase Difference Light Source Unit)

The first emission optical system 10 (the phase difference light source unit) includes a light emitting diode (LED) 101, a collimator 102, a ring slit 103, relay lenses 104 and 106, and a pinhole 105. The LED 101 emits incoherent visible light. It is desirable that the LED 101 be regarded as a point light source. For example, the LED 101 may be optically coupled with one end of a multimode fiber and emit visible light from the other end of the multimode fiber. The ring slit 103 includes a portion that annular light passes through and a light block portion other than the portion that annular light passes through. The ring slit 103 is disposed at a position P103 conjugate to the pupil plane P401 of the objective lens 401. The pinhole 105 is disposed at a position P105 conjugate to the focal plane P501 of the objective lens 401, which will be described below. The ring slit 103 may be alternatively referred to as a ring aperture 103, a ring-like slit 103, an annular slit 103, or the like.

The first emission optical system 10 (the phase difference light source unit) will be alternatively referred to as an irradiation optical system configured to emit first primary light including a spatially modulated component.

### (Phase Difference Detection Unit)

The first detection unit 70 (the phase difference detection unit) includes relay lenses 702 and 704, a pinhole 703, a phase plate 705, a tube lens 706, and a light detector 701. The pinhole 703 is disposed at a position P703 conjugate to the focal plane P501 of the objective lens 451. The phase plate 705 includes an annular portion corresponding to the ring slit 103 and a portion other than the annular portion. The annular portion is provided with a waveplate for shifting the phase of light by ¼ from the other portion and a neutral density (ND) filter for attenuating the light. The phase plate 705 is disposed at a position P705 conjugate to the pupil plane P451 of the objective lens 451. A light receiving plane of the light detector 701 is disposed on a focal plane P701 of the tube lens 706, and is disposed at a position conjugate to the focal plane P501 of the objective lens 451. The focal plane P701 may be alternatively referred to as a light receiving plane P701. The light detector 701 includes, for example, a photodiode or a photomultiplier tube. The intensity of the visible light received by the light detector 701 is acquired by the control unit 90 as a phase difference signal. The annular portion of the phase plate 705 according to the present embodiment may be alternatively referred to as a ring-like portion.

### (Second Emission Optical System)

The observation apparatus 1 according to the present embodiment includes pulse lasers 201 and 211 as pulsed light sources that are optically coupled with the second emission optical system and configured to emit two synchronized pulsed light beams having different oscillation wavelengths (two kinds of pulsed light). These two pulsed light beams include Stokes light and pump light both of which exhibit a non-linear optical effect on the sample 501.

The second emission optical system 20 (the SRS light source unit) includes the pulse lasers 201 and 211 different in oscillation wavelength and includes relay lenses 202 and 203 and a mirror 204 that correspond to the pulse laser 201, and relay lenses 212 and 213 and a dichroic mirror 214 that correspond to the pulse laser 211. The second emission optical system 20 (the SRS light source unit) further includes a pulse synchronization detection unit 221 for detecting synchronization between emission timings of the pulsed light beams from the pulse lasers 201 and 211. Thus, the second emission optical system 20 (the SRS light source unit) further includes beam splitters 222 and 223 that reflect parts of the light beams emitted from the pulse lasers 201 and 211, respectively, to guide the parts of the light to the pulse synchronization detection unit 221.

Examples usable as the pulse lasers 201 and 211 include mode-locked picosecond titanium: sapphire laser, a mode-locked picosecond neodymium laser, and a mode-locked picosecond ytterbium laser. One of the pulse lasers 201 and 211 may be replaced with an optical parametric oscillator that converts the wavelength of the pulsed light generated by the other of the pulse lasers 201 and 211.

One of the pulsed light beams emitted from the pulse lasers 201 and 211 that has a shorter wavelength is used as the pump light in the SRS observation, and the other light having a longer wavelength is used as the Stokes light in the SRS observation.

The repetition frequencies of the pulsed light emitted from the pulse lasers 201 and 211 are such that one is ½ of the other. For example, the repetition frequency of the Stokes light is ½ of the repetition frequency of the pump light. The synchronization between the pump light and the Stokes light is detected by the pulse synchronization detection unit 221. For example, a cavity length of one or both of the pulse lasers 201 and 211 is controlled by the control unit 90 based on a synchronization signal of the pulse synchronization detection unit 221, and the synchronized state between the pump light and the Stokes light is maintained for a long time sufficient for the SRS observation.

The dichroic mirror 214 has wavelength characteristics that transmit the pulsed light emitted from the pulse laser 201 while reflecting the pulsed light emitted from the pulse laser 211. The dichroic mirror 214 is disposed in such a manner that the transmitted light and the reflected light are coaxially superimposed.

The pulse synchronization detection unit 221 includes a mirror 224, a dichroic mirror 225, a lens 226, and a two-photon detector 227. The dichroic mirror 225 has wavelength characteristics that transmit the pulsed light emitted from the pulse laser 201 while reflecting the pulsed light emitted from the pulse laser 211. The dichroic mirror 225 is disposed in such a manner that the transmitted light and the reflected light are coaxially superimposed. The two-photon detector 227 detects two-photon absorption that occurs when both the pulsed light beams as the pump light and the Stokes light arrive at the same time.

The pulse lasers 201 and 211 and the pulse synchronization detection unit 221 may include an optical delay path (not illustrated) as necessary.

### (Second Detection Unit)

The second detection unit 80 (the SRS detection unit) includes a bandpass filter 802, a lens 803, and a light detector 801. The bandpass filter 802 has wavelength characteristics that transmit only one of the pump light and the Stokes light that is pulsed light emitted at a higher repetition frequency. The lens 803 reduces the beam diameter of the pulsed light transmitted through the bandpass filter 802 to a size that fits in the light receiving plane of the light detector 801. The light detector 801 includes, for example, a photodiode. By performing lock-in detection on a modulation component of the intensity of the pulsed light received by the light detector 801 in the control unit 90, an SRS signal is acquired.

### (Scanning Unit)

The scanning unit 30 includes a biaxial scanner 301 and relay lenses 302 and 303. The biaxial scanner 301 includes two mirrors tiltable about two axes orthogonal to each other, and two-dimensionally displaces the angle of the incident light with respect to the optical axis. The displacement amount is controlled by the degree of the tilt, and the scanning range on the sample plane P501 is controlled by that. The sample plane P501 is two-dimensionally scanned by causing the two mirrors to tilt at frequencies different from each other. It is desirable that the middle of the two mirrors be located at a position conjugate to the pupil plane P401 of the objective lens 401 via the relay lenses 302 and 303. The biaxial scanner 301 can be implemented by, for example, a combination of a resonant scanner and a galvanometer scanner, both of which are uniaxial scanners. With such configurations of the relay lenses 302 and 303, the light enters the pupil of the objective lens 401 with an appropriate beam diameter and a maximum angle.

### (Relay Unit)

The relay unit 60 includes relay lenses 601 and 602 and a biaxial scanner 603. The light enters the biaxial scanner 603 with an appropriate beam diameter and a maximum angle by the relay lenses 601 and 602. The biaxial scanner 603 includes two mirrors tiltable about two axes orthogonal to each other. These mirrors tilt to cancel out the displacement of the angle of the incident light flux with respect to the optical axis.

In other words, one and the other of the mirrors of the biaxial scanner 603 tilt at the same frequencies as and in phase or in opposite phase (depending on how they are installed) with one and the other of the mirrors of the biaxial scanner 301, respectively. Therefore, the light flux exiting from the biaxial scanner 603 travels in parallel with the optical axis or, ideally, travels on the optical axis. The operation of this biaxial scanner 603 may be referred to as reverse scanning (de-scanning). It is desirable that the middle of the two mirrors of the biaxial scanner 603 be disposed at a position conjugate to the pupil plane P451 of the objective lens 451 via the relay lenses 601 and 602.

Especially, when the objective lens 451 and the objective lens 401 are the same lenses, the same lenses as the relay lenses 303 and 302 can be used for the relay lenses 601 and 602, respectively, and the same scanner as the biaxial scanner 301 can be used as the biaxial scanner 603. In this case, the relay lenses 601 and 602 and the biaxial scanner 603 may be arranged symmetrically with the relay lenses 303 and 302 and the biaxial scanner 301 with respect to the sample plane P501.

The relay unit 60 according to the first embodiment including the biaxial scanner 603 may be alternatively referred to as a de-scanning unit 60 in terms of its functionality. The de-scanning unit 60 is configured to conduct de-scanning in synchronization with the scanning unit 30 on the optical path between the splitting unit 75 and the second objective lens 45.

### (Combining Unit and Splitting Unit)

The combining unit 15 and the splitting unit 75 include dichroic mirrors 151 and 751, respectively. The dichroic mirror 151 has wavelength characteristics that transmit the light emitted from the LED 101 while reflecting the light emitted from the pulse lasers 201 and 211. The dichroic mirror 151 is disposed in such a manner that the reflected light and the transmitted light are coaxially superimposed. The dichroic mirror 751 has wavelength characteristics that transmit the light emitted from the LED 101 and the light exiting from the sample 501, while reflecting the light emitted from the pulse lasers 201 and 211 and the light exiting from the sample 501.

### (Control Unit)

The control unit 90 includes a control device 901, a keyboard 911, a mouse 912, and a display 921. The control device 901 may be implemented by providing a computer with a program that causes the computer to execute a control flow. Further, the control device 901 may be equipped with a field-programmable gate array (FPGA), a microcomputer, or an electric circuit that executes a part of the control flow, and a part of the program may be implemented thereon. A lock-in amplifier (not illustrated) for detecting the modulation component of the light intensity detected by the light detector 801 for the SRS observation is also included in the control device 901. This intensity modulation may be alternatively referred to as the SRS signal. Further, for example, an electric circuit that controls one or both of the pulse lasers 201 and 211 based on the synchronization signal of the pulse synchronization detection unit 221 may also be included in the control device 901. Further, for example, an electric circuit that generates driving signals of the biaxial scanners 301 and 603 can also be included in the control device 901.

The control device 901 generates the phase difference image and the SRS image based on signals output from the light detector 701 and the light detector 801, respectively. In this processing, the control device 901 reads out the phase difference signal and the SRS signal at the same pixel frequency (pixel rate) and converts each of the signals into luminance, whereby images having the same number of pixels are generated. The generated phase difference image and SRS image are, for example, stored into a storage device (not illustrated) of the control device 901 and/or output toward the display 921. The storage device is, for example, a solid state drive or a hard disk drive.

The keyboard 911 and the mouse 912 are connected to the control device 901, and the operator inputs an instruction to the control device 901 by operating the keyboard 911 and the mouse 912. The control device 901 is connected to the LED 101, the pulse laser 201, the pulse laser 211, the biaxial scanners 301 and 603, the stage scanner 512, and the light detectors 701 and 801, and controls their operations according to the instruction issued from the operator.

The display 921 provides visual feedback to the operator in response to the operator's operation and also displays an image and a character string output from the control device 901.

### (Phase Difference Observation)

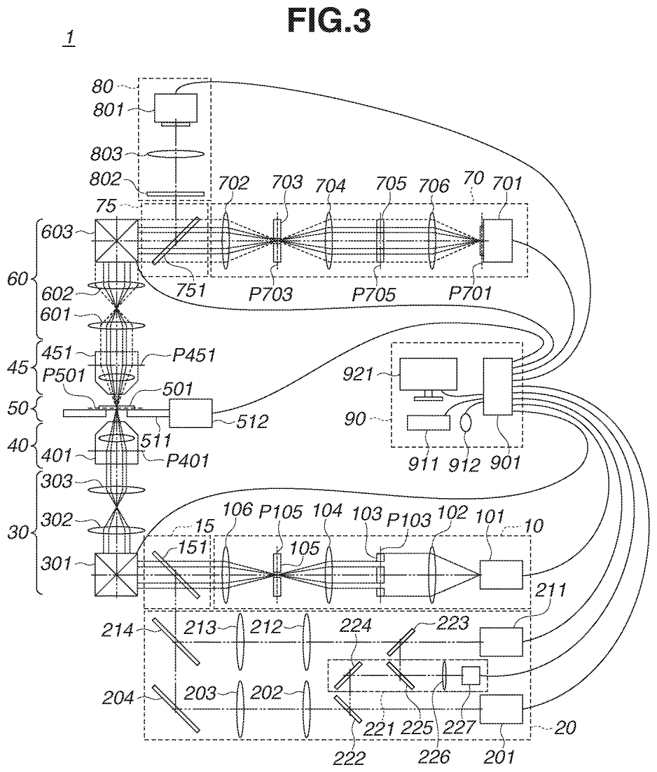

FIG. 3 is a schematic view illustrating the phase difference observation by the observation apparatus 1. The phase difference observation conducted by the observation apparatus 1 uses the first emission optical system 10 (the phase difference light source unit), the combining unit 15, the scanning unit 30, the first objective lens 40, the placement unit 50, the second objective lens 45, the relay unit 60, the splitting unit 75, the first detection unit 70 (the phase difference detection unit), and the control unit 90.

As indicated by a dotted line in FIG. 3, the light emitted from the LED 101 of the first emission optical system 10 (the phase difference light source unit) is collimated into a collimated light flux by the collimator 102. The annular light flux transmitted through the ring slit 103 is condensed to one point toward the pinhole 105 by the relay lens 104. At this time, first or higher-order diffracted light generated at the edge of the ring slit 103 widens the light condensation point. The pinhole 105 blocks light of a peripheral portion of this light condensation point and transmits light near the center, which increases the ratio of light traveling straight through the ring slit 103 (i.e., zeroth-order diffracted light). This helps to prevent the light, re-formed into an annular shape by the relay lens 106, from losing its annular shape during propagation through the subsequent optical path. Consequently, artifacts on the acquired phase difference image are suppressed.

The collimated light flux enlarged or reduced in the annular diameter by the relay lens 106 passes through the dichroic mirror 151 of the combining unit 15 and enters the biaxial scanner 301 of the scanning unit 30.

The annular light flux is reflected by each of the two mirrors of the biaxial scanner 301. The annular light flux exiting from the biaxial scanner 301 in parallel or obliquely with respect to the optical axis is enlarged or reduced in annular diameter by the relay lenses 302 and 303, and enters the objective lens 401 of the first objective lens 40. The light flux is condensed to one point toward the sample 501 on the placement unit 50 by the objective lens 401. The position of this light condensation point in the sample plane P501 corresponds to the angle of the light flux exiting from the biaxial scanner 301 with respect to the optical axis. At this time, first or higher-order diffracted light according to the refractive index profile and the shape of the sample 501 is generated in addition to the direct light that travels straight through the sample 501 (i.e., zeroth-order diffracted light).

The direct light and the diffracted light departing from the sample 501 are collected by the objective lens 451, and emitted in the form of a collimated light flux. At this time, the direct light at the sample 501 is annular, and diffracted-light components generated at the sample 501 are distributed on the inner and the outer sides of the annular light. The emission angle of this collimated light flux corresponds to the position of the light condensation point in the sample plane P501, i.e., the angle of the light flux exiting from the biaxial scanner 301 with respect to the optical axis. The light flux exiting from the objective lens 451 is enlarged or reduced in beam diameter by the relay lenses 601 and 602 of the relay unit 60, and enters the biaxial scanner 603. This light flux is reflected by the two mirrors of the biaxial scanner 603. The light flux exiting from the biaxial scanner 603 in parallel or coaxially with the optical axis regardless of the incident angle passes through the dichroic mirror 751 of the splitting unit 75, and enters the relay lens 702 of the first detection unit 70 (the phase difference detection unit).

The relay lens 702 condenses the light flux to one point toward the pinhole 703. The pinhole 703 blocks light of a peripheral portion of this light condensation point to block diffracted light and scattered light generated at portions other than the light condensation point in the sample plane P501. Consequently, artifacts on the acquired phase difference image are suppressed.

The light flux transmitted through the pinhole 703 is enlarged or reduced in beam diameter by the relay lens 704 and collimated again into a collimated light flux, and passes through the phase plate 705. At this time, the direct light from the sample 501 passes through the annular portion and is subjected to phase modulation and attenuation, and the diffracted light from the sample 501 passes through the portions other than the annular portion. The light flux exiting from the phase plate 705 is condensed by the tube lens 706 to one point toward the light receiving plane P701 of the light detector 701. The direct light and the diffracted light from the sample 501 interfere with each other on the light receiving plane P701, and the resulting light intensity is detected by the light detector 701.

### (SRS Observation)

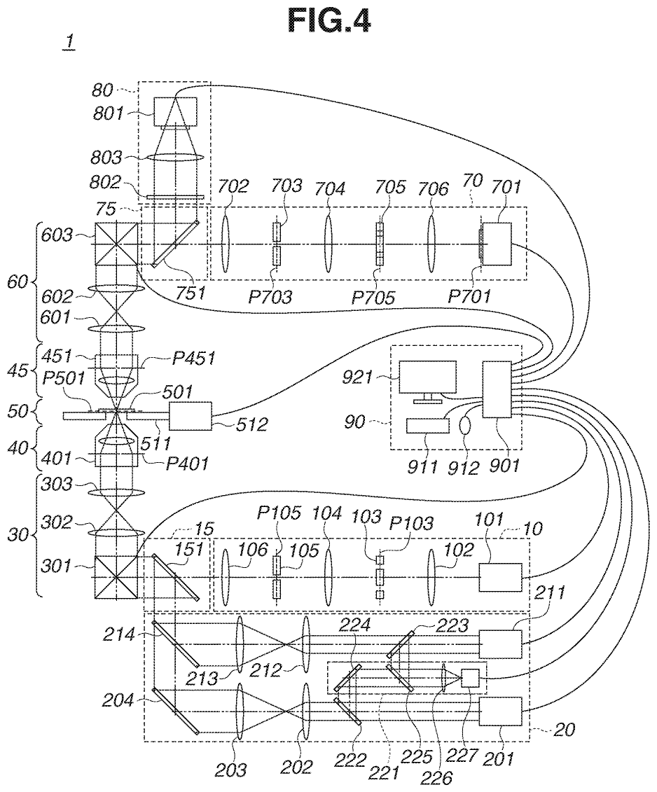

FIG. 4 is a schematic view illustrating the SRS observation by the observation apparatus 1. The SRS observation conducted by the observation apparatus 1 uses the second emission optical system 20 (the SRS light source unit), the combining unit 15, the scanning unit 30, the first objective lens 40, the placement unit 50, the second objective lens 45, the relay unit 60, the splitting unit 75, the second detection unit 80 (the SRS detection unit), and the control unit 90.

As indicated by a dotted line in FIG. 4, part of the collimated light flux emitted from the pulse laser 201 of the SRS light source unit is reflected by the beam splitter 222 and enters the pulse synchronization detection unit 221, while most of the light is transmitted and enters the relay lens 202. The light flux enlarged or reduced in beam diameter by the relay lenses 202 and 203 is reflected on the mirror 204, and then passes through the dichroic mirror 214.

The collimated light flux emitted from the pulse laser 211 is partially reflected by the beam splitter 223 and enters the pulse synchronization detection unit 221, while most of the light is transmitted and enters the relay lens 212. The light flux enlarged or reduced in beam diameter by the relay lenses 212 and 213 is reflected by the dichroic mirror 214. At this time, this light flux is coaxially superimposed with the above-described light flux transmitted through the dichroic mirror 214.

The light flux from the pulse laser 201 that has been reflected by the beam splitter 222 is reflected by the mirror 224 of the pulse synchronization detection unit 221 and is transmitted through the dichroic mirror 225. The light flux from the pulse laser 211 that has been reflected by the beam splitter 223 is reflected by the dichroic mirror 225. At this time, this light flux is coaxially superimposed with the light flux transmitted through the dichroic mirror 225. This coaxially superimposed light flux (i.e., both the light fluxes of the pump light and the Stokes light) is condensed toward the two-photon detector 227 by the lens 226.

The light flux coaxially superimposed by the dichroic mirror 214 (i.e., both the light fluxes of the pump light and the Stokes light) is reflected by the dichroic mirror 151 of the combining unit 15. At this time, the reflected light flux is coaxially superimposed with the annular light flux that has been emitted from the first emission optical system 10 (the phase difference light source unit) and transmitted through the dichroic mirror 151.

The light flux reflected by the dichroic mirror 151 enters the biaxial scanner 301 of the scanning unit 30, and is reflected by each of the two mirrors. The light flux exiting from the biaxial scanner 301 is enlarged or reduced in beam diameter by the relay lenses 302 and 303, and enters the objective lens 401 of the first objective lens 40. The objective lens 401 condenses the light flux to one point toward the sample 501 on the placement unit 50. The position of the light condensation point in the sample plane P501 corresponds to the angle at which the light flux exits from the biaxial scanner 301 with respect to the optical axis. At this time, an SRS process occurs at the light condensation point. More specifically, a stimulated Raman loss occurs with respect to the pump light and a stimulated Raman gain occurs with respect to the Stokes light in correspondence with a vibration level of molecules present at the light condensation point. In addition to the pump light and the Stokes light, the light emitted from the first emission optical system 10 (the phase difference light source unit) is also condensed coaxially, and thus the light condensation point coincides. Therefore, the SRS image and the phase difference image are acquired simultaneously and correspond to the same field of view.

The pump light and the Stokes light departing from the sample 501 are each collected by the objective lens 451, and emitted in the form of a collimated light flux. At this time, the emission angle with respect to the optical axis corresponds to the position of the light condensation point in the sample plane P501, i.e., the angle of the light flux exiting from the biaxial scanner 301 with respect to the optical axis. The light flux exiting from the objective lens 451 is enlarged or reduced in beam diameter by the relay lenses 601 and 602 of the relay unit 60, and enters the biaxial scanner 603.

The light flux is reflected by each of the two mirrors of the biaxial scanner 603. The light fluxes of the pump light and the Stokes light exiting from the biaxial scanner 603 in parallel or coaxially with the optical axis regardless of the incident angle are reflected by the dichroic mirror 751 of the splitting unit 75 and enter the bandpass filter 802 of the second detection unit 80 (the SRS detection unit). The bandpass filter 802 transmits only one of the pump light and the Stokes light that has a higher repetition frequency of the pulse, and blocks the other light having a lower repetition frequency (½ of the higher one). The light flux transmitted through the bandpass filter 802 is condensed toward the light receiving surface of the light detector 801 by the lens 803, and the light detector 801 detects intensity of the resulting light.

### (Observation Flow)

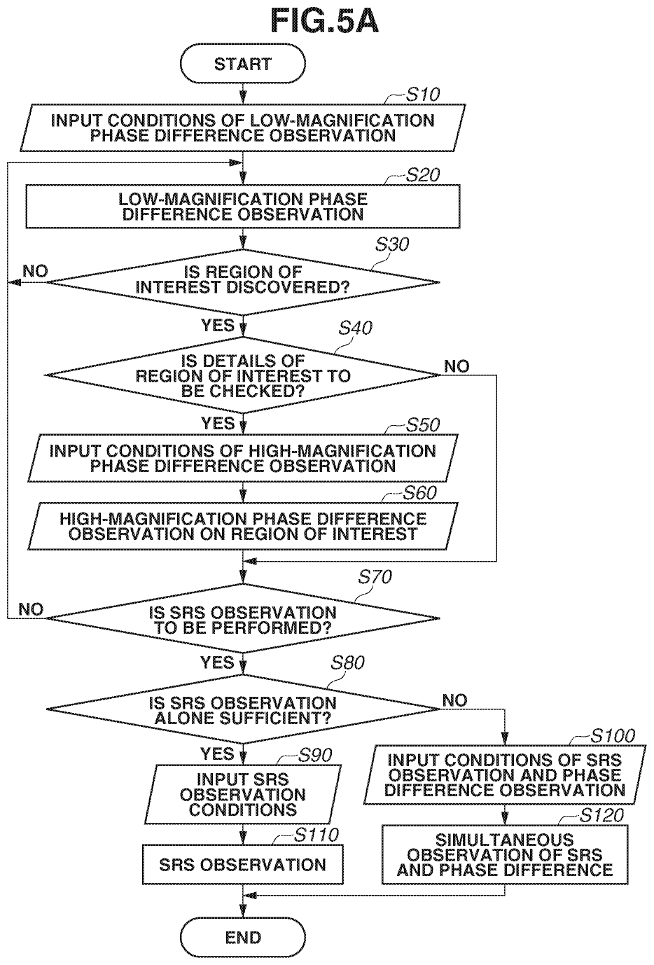

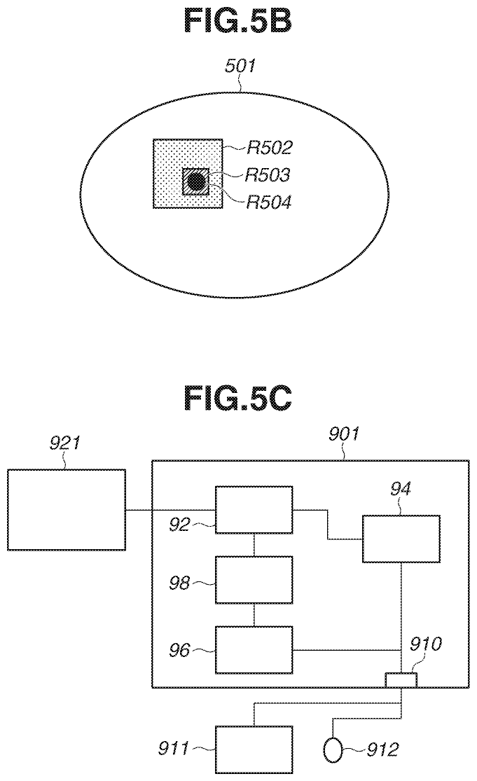

FIGS. 5A to 5C illustrate an example of a flow of observation of the sample 501 using the observation apparatus 1. FIG. 5A is a flowchart illustrating the observation flow, and FIG. 5B illustrates a low-magnification field of view R502, a high-magnification field of view R503, and a region of interest R504 in the flowchart. FIG. 5C illustrates an overview of the configuration of the scanning condition determination unit. The region of interest R504 may be alternatively referred to as a target region R504.

As illustrated in FIG. 5C, the control unit 90 includes an image generation unit 92 for generating a first image captured by the first objective lens 40 of a predetermined magnification and the second objective lens 45 and for displaying the first image on the display 921 (display unit). The control unit 90 further includes an input unit 910 for receiving an input of information regarding a region of interest from the operator based on the displayed first image, and a scanning condition acquisition unit 94 for acquiring a scanning condition SC0 for the scanning unit 30 based on the received information regarding the region of interest. The control unit 90 further includes a scanning condition determination unit 96 for determining a scanning condition SC1 employed at the time of imaging for the scanning unit 30 based on the acquired scanning condition SC0. The control unit 90 further includes an update unit 98 for displaying the scanning condition SC1 determined by the scanning condition determination unit 96 on the display 921 and receiving an update of the scanning condition SC1.

First, the sample 501 is held on the stage 511. The observation flow is started from this state. Then, the phase difference observation is conducted on the sample 501 in a wide field of view. In steps S10 and S20, conditions of low-magnification phase difference observation are input to the control device 901, and the low-magnification phase difference observation is started.

The low-magnification field of view R502 illustrated in FIG. 5B is moved by changing the position of the stage 511 driven by the stage scanner 512. In a case where the region of interest R504 of the sample 501 is not present in the low-magnification field of view R502 (NO in step S30), the low-magnification field of view R502 is moved and the low-magnification phase difference observation is continued. On the other hand, in a case where the region of interest R504 is discovered (YES in step S30), the low-magnification phase difference observation is completed. By first conducting the phase difference observation of the sample 501 in real time in a wide field of view in this manner, the time required to grasp the position of the sample 501 with respect to the sample plane P501 and to discover the region of interest R504 can be shortened. This can help to suppress damage to the sample 501.

Subsequently, in step S40, determination of whether to check the details of the phase difference image of the region of interest R504 is performed based on the low-magnification phase difference image. In a case where it is determined that the details are to be checked (YES in step S40), the phase difference observation is conducted in real time in a narrower field of view. In this case, in steps S50 and S60, conditions of high-magnification phase difference observation are input to the control device 901, and the high-magnification phase difference observation is started. As necessary, the high-magnification field of view R503 illustrated in FIG. 5B is moved in such a manner that the region of interest R504 is fitted within the high-magnification field of view R503, and the necessity of the SRS observation is evaluated based on the high-magnification phase difference image. On the other hand, in a case where it is determined that the details of the phase difference image of the region of interest R504 are not to be checked (NO in step S40), the necessity of the SRS observation is evaluated based on the low-magnification phase difference image. In a case where it is determined that the SRS observation is not to be performed based on these phase difference images (NO in step S70), the processing returns to the low-magnification phase difference observation, and searches for another region of interest R504 of the sample 501. On the other hand, in a case where it is determined that the SRS observation is to be performed (YES in step S70), the processing proceeds to the SRS observation. In this manner, the necessity of the SRS observation can be quickly determined by smoothly expanding the region of interest R504 of the sample 501 and conducting the phase difference observation. The present observation flow can reduce unnecessary SRS observation, which helps to suppress damage to the sample in addition to making the measurement efficient.

Subsequently, in step S80, determination of whether to conduct the SRS observation alone or conduct both the SRS observation and the phase difference observation is performed before the SRS observation is started. In a case where it is determined that the SRS observation is to be conducted alone (YES in step S80), in steps S90 and S110, the SRS observation conditions are input to the control device 901 and the SRS observation is started. On the other hand, in a case where it is determined that both the SRS observation and the phase difference observation are to be conducted (NO in step S80), in steps S100 and S120, both the SRS observation conditions and the phase difference observation conditions are input to the control device 901, and simultaneous observation of the SRS observation and the phase difference observation is started. After the SRS observation or the simultaneous observation of the SRS observation and the phase difference observation is completed, the observation flow including the series of steps is ended. In this manner, at the time of observation requiring the SRS image and the phase difference image acquired at the same time point, such as observation of a dynamic event of the sample 501, selecting the simultaneous observation of both of them improves the observation accuracy. On the other hand, in a case where the phase difference image is not required, irradiation of unnecessary light to the sample 501 is prevented, which helps to suppress damage to the sample 501.

The low-magnification and high-magnification phase difference observation conditions include, for example, the intensity of the light output of the LED 101, the number of accumulations, and the size of the field of view. The SRS observation conditions include, for example, the intensity and the wavelength of the light output from each of the pulse lasers 201 and 211, the number of accumulations, and the size of the field of view.

According to the observation flow illustrated in FIG. 5A, in a case where the region of interest R504 is discovered in step S30, the operator inputs the respective observation conditions in steps S50, S90, and S100 after that. To improve the usability for the operator, step S35, in which the operator inputs positional information about the region of interest R504, may be added between steps S30 and S40. The positional information may be input, for example, by the operator using the mouse 912 to trace the outline of the region of interest R504 or to draw a mark on the low-magnification phase difference image displayed on the display 921 of the control unit 90. Then, the control device 901 may estimate appropriate respective observation conditions based on the above-described positional information and present them to the operator in steps S50, S90, and S100. In this manner, by assisting the operator in inputting the respective observation conditions, the burden on the operator can be reduced.

In the case where the above-described step S35 is added, the control device 901 may determine appropriate observation conditions based on the above-described positional information and automatically input the respective observation conditions in steps S50, S90, and S100. This can eliminate the need for the operator to input the respective observation conditions, which further reduces the operator's burden.

In the observation apparatus 1 illustrated in FIG. 2, the ring slit 103 and the phase plate 705 are disposed in the first emission optical system 10 (the phase difference light source unit) and the first detection unit 70 (the phase difference detection unit), respectively, but the phase difference image is still obtainable even when their positions are switched.

In the above-described manner, the observation apparatus 1 according to the first embodiment of the present disclosure simultaneously acquires the phase difference signal and the SRS signal from the same point and generates the phase difference image and the SRS image having the same number of pixels. In other words, the observation apparatus 1 acquires the primary images of the phase difference image and the SRS image having consistent image qualities. This can reduce the burden on the operator associated with achieving consistency in the image quality.

### Second Embodiment

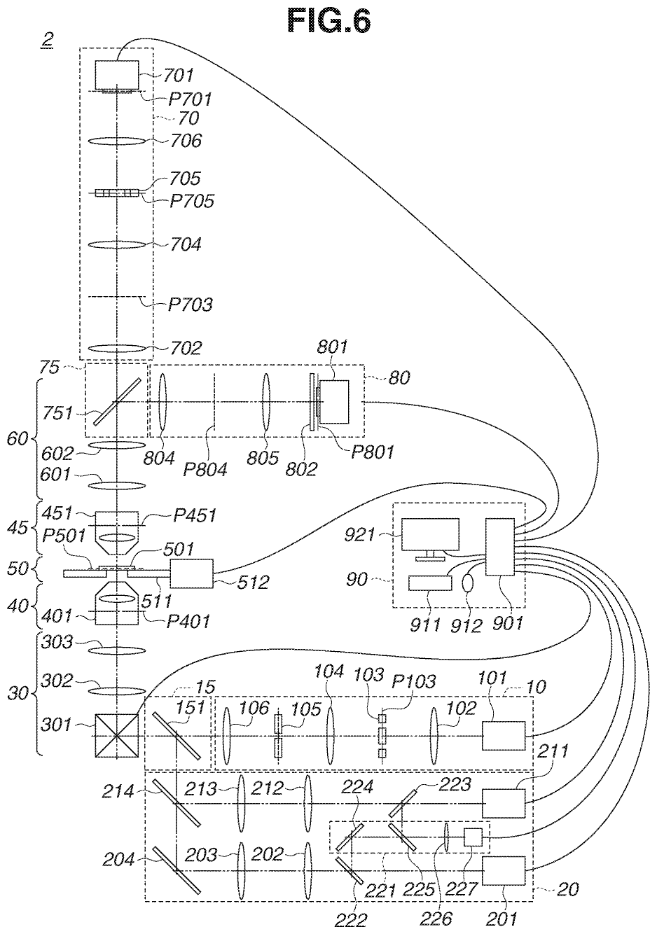

A configuration of an observation apparatus according to a second embodiment will be described with reference to FIG. 6. FIG. 6 is a schematic view illustrating the configuration of an observation apparatus 2 according to the present embodiment. The observation apparatus 2 is configured similarly to the observation apparatus 1 according to the first embodiment except for differences that will be described below. Therefore, common elements will be identified by the same reference numerals, and the redundant descriptions will be omitted.

The observation apparatus 2 illustrated in FIG. 6 does not include the biaxial scanner 603 of the relay unit 60 of the observation apparatus 1, and a dichroic mirror 751 of a splitting unit 75 is disposed at the position instead. In addition, the pinhole 703 of the first detection unit 70 (the phase difference detection unit) of the observation apparatus 1 is removed. Further, the lens 803 of the second detection unit 80 (the SRS detection unit) of the observation apparatus 1 is replaced with relay lenses 804 and 805. A relay unit 60 according to the present embodiment is different from the relay unit 60 according to the first embodiment in terms of not being electrically connected to a control unit 90.

### (Relay Unit)

The observation apparatus 2 includes no biaxial scanner for canceling out the displacement of the angle of the light flux incident to the relay unit 60 with respect to the optical axis. Thus, the angle of the light flux exiting from the relay unit 60 of the observation apparatus 2 with respect to the optical axis corresponds to the position of the light condensation point in a sample plane P501, i.e., the angle of the light flux exiting from a biaxial scanner 301 of a scanning unit 30 with respect to the optical axis.

### (Splitting Unit)

The dichroic mirror 751 of the splitting unit 75 of the observation apparatus 2 has wavelength characteristics similar to the wavelength characteristics of the dichroic mirror 751 of the observation apparatus 1. The dichroic mirror 751 of the observation apparatus 2 is disposed near a position conjugate to a pupil plane P451 of an objective lens 451 of a second objective lens 45 via relay lenses 601 and 602 of the relay unit 60.

### (Phase Difference Detection Unit)

The first detection unit 70 (the phase difference detection unit) of the observation apparatus 2 does not include the pinhole 703 at a position P703 (i.e., an intermediate imaging plane) conjugate to the focal plane P501 of the objective lens 451. On the intermediate imaging plane P703, a point-like image moves in correspondence with the light condensation point that scans the sample plane P501. Similarly, a point-like image also moves in a focal plane P701 of a tube lens 706 disposed at a position conjugate to the focal plane P501. Thus, the light detector 701 of the observation apparatus 2 requires a wide light receiving area compared with the observation apparatus 1. The light detector 701 of the observation apparatus 2 may use a photodiode array in which a plurality of photodiodes is two-dimensionally arranged, or an image sensor.

A phase plate 705 of the first detection unit 70 (the phase difference detection unit) of the observation apparatus 2 is similar to the phase plate 705 of the observation apparatus 1 in terms of being disposed at a position conjugate to the pupil plane P451 of the objective lens 451. The difference of the phase plate 705 of the observation apparatus 2 from the phase plate 705 of the observation apparatus 1 is that the angle of the light flux transmitted through the phase plate 705 with respect to the optical axis varies in correspondence with the position of the light condensation point in the sample plane P501, i.e., varies in correspondence with the angle of the light flux exiting from the biaxial scanner 301 with respect to the optical axis. In view of this, the annular portion needs to be designed to modulate the phase of the direct light (the zeroth-order diffracted light) at the sample 501 and to attenuate the direct light.

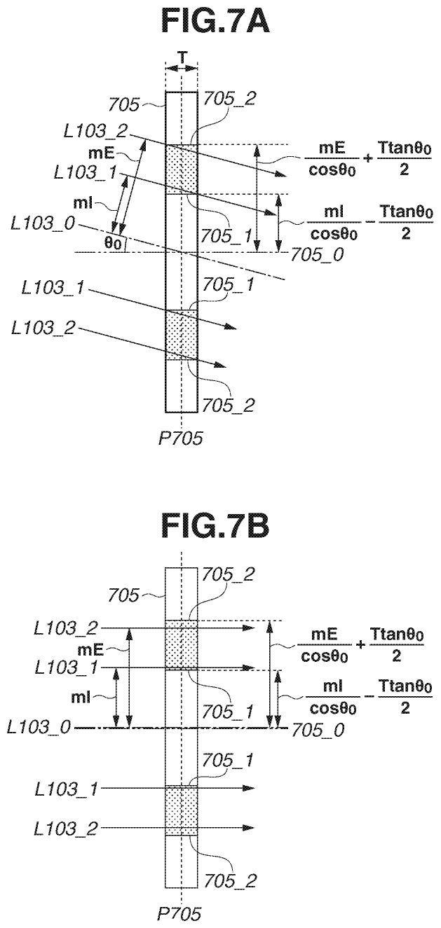

FIGS. 7A and 7B are schematic views illustrating the relationship between the phase plate 705 of the observation apparatus 2 and light fluxes transmitted therethrough. The phase plate 705 includes two concentric cylinders 705_1 and 705_2 around a central axis 705_0 coincident with the optical axis. A quarter-wave plate and an ND filter are disposed in a region (a shaded portion in FIGS. 7A and 7B) between the inner cylinder 705_1 and the external cylinder 705_2. Through this region, annular collimated light fluxes generated from the direct light on the sample 501 are transmitted. Among these annular light fluxes, an innermost light flux L103_1 and an outermost light flux L103_2 draw concentric cylinders around a chief ray of the collimated light fluxes transmitted through the phase plate 705 (including both the direct light and the diffracted light at the sample 501). The diameters of the cylinders of these light fluxes L103_1 and L103_2 correspond to the inner diameter and the outer diameter of the ring slit 103 present at the position conjugate to a plane P705 where the center of the thickness of the phase plate 705 is located, respectively. More specifically, the radius of the light flux L103_1 and the radius of the light flux L103_2 are calculated as ml and mE by multiplying an inner radius I and an outer radius E of the ring slit 103, respectively, by an imaging magnification m.

FIG. 7A illustrates when the angles of the collimated light fluxes transmitted through the phase plate 705 with respect to the optical axis are maximized. In FIG. 7A, a chief ray L103_0 forms a maximum angle θ₀ with the optical axis 705_0, and intersects with the optical axis 705_0 on the plane P705, which coincides with the center of the thickness of the phase plate 705. At this time, all of light fluxes between the light fluxes L103_1 and L103_2 are transmitted through the region between the cylinders 705_1 and 705_2 of the phase plate 705, and thus the radii of the cylinders 705_1 and 705_2 satisfy the following equations 1 and 2.

$$( the radius of the cylinder 701 \_ 1 ) \leq \frac{mI}{cos {θ}_{0}} - \frac{T tan {θ}_{0}}{2} \qquad Equation 1$$

$$( the radius of the cylinder 701 \_ 2 ) \leq \frac{mE}{cos {θ}_{0}} - \frac{T tan {θ}_{0}}{2} \qquad Equation 2$$

In the equation 1 and the equation 2, the incident angles of the light fluxes to the phase plate 705 are treated as being no greater than 10°, and refraction caused by the quarter-wave plate, the ND filter, and the like is disregarded. It is desirable to determine the above-described radii in consideration of these refractions to be more precise.

FIG. 7B illustrates when the collimated light fluxes transmitted through the phase plate 705 are parallel with the optical axis. When the equations 1 and 2 are satisfied, all light fluxes between the light fluxes L103_1 and L103_2 are transmitted through the region between the cylinders 705_1 and 705_2 of the phase plate 705.

Artifacts on the acquired phase difference image can be suppressed by designing the phase plate 705 in such a manner that all direct light fluxes at the sample 501 are subjected to phase modulation and attenuation on the phase plate 705 regardless of the angle with respect to the optical axis at the time of the transmission through the phase plate 705 in this manner.

### (SRS Detection Unit)

The second detection unit 80 (the SRS detection unit) of the observation apparatus 2 includes the relay lenses 804 and 805, the bandpass filter 802, and the light detector 801. The relay lenses 804 and 805 enlarge or reduce the beam diameter of an incident light flux to adjust it to the size of the light receiving surface of the light detector 801. A plane P804 conjugate to the focal plane P501 of the objective lens 451 of the second objective lens 45 is present between the relay lenses 804 and 805. The light receiving surface of the light detector 801 of the observation apparatus 2 is disposed at a position conjugate to the pupil plane P451 of the objective lens 451. The bandpass filter 802 of the observation apparatus 2 has wavelength characteristics similar to the wavelength characteristics of the observation apparatus 1, and is disposed between the relay lens 805 and the light detector 801.

In this manner, the observation apparatus 2 according to the second embodiment of the present disclosure, which includes no biaxial scanner in the relay unit 60, facilitates the optical adjustment in addition to simplifying the control. Consequently, the stability of the observation apparatus 2 is improved.

In the above-described embodiments, coherent pulsed light of different wavelengths is condensed at the sample to cause an SRS process, and imaging is performed to acquire a Raman image with high sensitivity and at a high speed. Alternatively, a Raman image may also be acquired by condensing incoherent light of a predetermined wavelength at the sample, causing a spontaneous Raman scattering process, and performing imaging. As the detection unit in this case, a monochromator may be used, for example. Even in this case, similar advantageous effects can also be acquired.

Although the present disclosure has been described above with reference to the embodiments, the technical scope of the present disclosure is not limited to the scope described in the above embodiments. It will be apparent to those skilled in the art that various modifications or improvements can be made to the above embodiments. It is also apparent from the recitations of the claims that embodiments to which such modifications or improvements have been made may be included within the technical scope of the present disclosure.

The scanning observation apparatus according to the embodiments of the present disclosure includes the following configurations 1 to 14.

### (Configuration 1)

A scanning observation apparatus comprising:
a first emission optical system configured to emit first primary light containing a spatially modulated component;
a second emission optical system configured to emit coherent second primary light;
a combining unit configured to coaxially combine the first primary light and the second primary light;
a scanning unit configured to coaxially scan the combined first primary light and second primary light;
a first objective lens configured to condense the scanned first primary light and second primary light;
a placement unit configured to place a sample at a light condensation point of the first objective lens;
a second objective lens configured to collect secondary light from the sample;
a splitting unit configured to split the secondary light into first secondary light exiting from the sample by irradiation with the first primary light, and second secondary light exiting from the sample by irradiation with the second primary light;
a first detection unit configured to detect the first secondary light; and
a second detection unit configured to detect the second secondary light.

### (Configuration 2)

The scanning observation apparatus according to configuration 1, further comprising a pulsed light source optically coupled with the second emission optical system and configured to emit two synchronized pulsed light beams having different oscillation wavelengths.

### (Configuration 3)

The scanning observation apparatus according to configuration 2, wherein the two pulsed light beams include Stokes light and pump light that each exhibit a nonlinear optical effect with respect to the sample.

### (Configuration 4)

The scanning observation apparatus according to any one of configurations 1 to 3, wherein the second secondary light includes light exiting from the sample by a nonlinear optical effect that occurs at the sample by irradiation with the second primary light.

### (Configuration 5)

The scanning observation apparatus according to any one of configurations 1 to 4, wherein the first emission optical system includes a first light source configured to emit incoherent light having a predetermined wavelength.

### (Configuration 6)

The scanning observation apparatus according to any one of configurations 1 to 5, wherein the first emission optical system includes a modulation optical element configured to annularly modulate an intensity component of the first primary light. The first detection unit includes a demodulation optical element including an annular portion configured to demodulate an intensity component and a phase component of the first secondary light.

### (Configuration 7)

The scanning observation apparatus according to any one of configurations 1 to 6, wherein the first emission optical system includes a pinhole configured to block a part of the condensed first primary light.

### (Configuration 8)

The scanning observation apparatus according to any one of configurations 1 to 7, wherein the first emission optical system includes a modulation optical element including an annular portion configured to modulate an intensity component and a phase component of the first primary light. The first detection unit includes a demodulation optical element configured to annularly demodulate an intensity component of the first secondary light.

### (Configuration 9)

The scanning observation apparatus according to any one of configurations 1 to 8, further comprising a de-scanning unit in an optical path between the splitting unit and the second objective lens, the de-scanning unit being configured to perform de-scanning in synchronization with the scanning unit.

### (Configuration 10)

The scanning observation apparatus according to configuration 9, wherein the de-scanning unit condenses the first secondary light toward the first detection unit side, and wherein the first detection unit includes a pinhole configured to block a part of the condensed first secondary light.

### (Configuration 11)

The scanning observation apparatus according to any one of configurations 1 to 10, further comprising an image generation unit configured to generate a first image captured by the first objective lens of a predetermined magnification and the second objective lens, and to display the first image on a display unit.

### (Configuration 12)

The scanning observation apparatus according to configuration 11, further comprising an input unit configured to receive an input of information regarding a region of interest from an operator based on the first image displayed, and a scanning condition acquisition unit configured to acquire a scanning condition for the scanning unit based on the received information regarding the region of interest.

### (Configuration 13)

The scanning observation apparatus according to configuration 12, further comprising a scanning condition determination unit configured to determine a scanning condition employed at the time of imaging for the scanning unit based on the acquired scanning condition.

### (Configuration 14)

The scanning observation apparatus according to configuration 12, further comprising an update unit configured to display the scanning condition acquired from the scanning condition acquisition unit on the display unit and receive an update of the scanning condition.

The present disclosure is not limited to the above embodiments, and various changes and modifications can be made without departing from the spirit and scope of the present disclosure. Accordingly, the following claims are appended in order to particularly point out and distinctly claim the subject matter of the present disclosure.

According to the present disclosure, it becomes possible to provide an observation apparatus that facilitates matching of image quality between a phase difference image and a Raman image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A scanning observation apparatus comprising:
a first emission optical system configured to emit first primary light containing a spatially modulated component;
a second emission optical system configured to emit coherent second primary light;
a combining unit configured to coaxially combine the first primary light and the second primary light;
a scanning unit configured to coaxially scan the combined first primary light and second primary light;
a first objective lens configured to condense the scanned first primary light and second primary light;
a placement unit configured to place a sample at a light condensation point of the first objective lens;
a second objective lens configured to collect secondary light from the sample;
a splitting unit configured to split the secondary light into first secondary light exiting from the sample by irradiation with the first primary light, and second secondary light exiting from the sample by irradiation with the second primary light;
a first detection unit configured to detect the first secondary light; and
a second detection unit configured to detect the second secondary light.

2. The scanning observation apparatus according to claim 1, further comprising a pulsed light source optically coupled with the second emission optical system and configured to emit two synchronized pulsed light beams having different oscillation wavelengths.

3. The scanning observation apparatus according to claim 2, wherein the two pulsed light beams include Stokes light and pump light that each exhibit a nonlinear optical effect with respect to the sample.

4. The scanning observation apparatus according to claim 1, wherein the second secondary light includes light exiting from the sample by a nonlinear optical effect that occurs at the sample by irradiation with the second primary light.

5. The scanning observation apparatus according to claim 1, wherein the first emission optical system includes a first light source configured to emit incoherent light having a predetermined wavelength.

6. The scanning observation apparatus according to claim 1, wherein the first emission optical system includes a modulation optical element configured to annularly modulate an intensity component of the first primary light, and the first detection unit includes a demodulation optical element including an annular portion configured to demodulate an intensity component and a phase component of the first secondary light.

7. The scanning observation apparatus according to claim 1, wherein the first emission optical system includes a pinhole configured to block a part of the condensed first primary light.

8. The scanning observation apparatus according to claim 1, wherein the first emission optical system includes a modulation optical element including an annular portion configured to modulate an intensity component and a phase component of the first primary light, and the first detection unit includes a demodulation optical element configured to annularly demodulate an intensity component of the first secondary light.

9. The scanning observation apparatus according to claim 1, further comprising a de-scanning unit in an optical path between the splitting unit and the second objective lens, the de-scanning unit being configured to perform de-scanning in synchronization with the scanning unit.

10. The scanning observation apparatus according to claim 9,
wherein the de-scanning unit condenses the first secondary light toward the first detection unit side, and
wherein the first detection unit includes a pinhole configured to block a part of the condensed first secondary light.

11. The scanning observation apparatus according to claim 1, further comprising an image generation unit configured to generate a first image captured by the first objective lens of a predetermined magnification and the second objective lens, and to display the first image on a display unit.

12. The scanning observation apparatus according to claim 11, further comprising an input unit configured to receive an input of information regarding a region of interest from an operator based on the first image displayed on the display unit, and a scanning condition acquisition unit configured to acquire a scanning condition for the scanning unit based on the received information regarding the region of interest.

13. The scanning observation apparatus according to claim 12, further comprising a scanning condition determination unit configured to determine a scanning condition employed at the time of imaging for the scanning unit based on the acquired scanning condition.

14. The scanning observation apparatus according to claim 12, further comprising an update unit configured to display the scanning condition acquired from the scanning condition acquisition unit on the display unit and receive an update of the scanning condition.
